(19) United States
(12) Patent Application Publication
(10) Pub. No.: US 2015/0006268 A1
(43) Pub. Date: Jan. 1, 2015

(54) DESIGNING PRICE INCENTIVES IN A NETWORK WITH SOCIAL INTERACTIONS

(71) Applicant: International Business Machines Corporation, Armonk, NY (US)

(72) Inventors: Maxime C. Cohen, Cambridge, MA (US); Markus R. Ettl, Ossining, NY (US); Pavithra Harsha, Yorktown Heights, NY (US)

(73) Assignee: International Business Machines Corporation, Armonk, NY (US)

(21) Appl. No.: 14/029,035

(22) Filed: Sep. 17, 2013

Related U.S. Application Data
(63) Continuation of application No. 14/022,336, filed on Sep. 10, 2013.
(60) Provisional application No. 61/840,731, filed on Jun. 28, 2013.

(51) Int. Cl. G06Q 30/02; G06Q 50/00

(52) U.S. Cl. CPC G06Q 30/0214; G06Q 50/01
USPC 705/14.16

(57) ABSTRACT

Providing prices and incentives, in one aspect, may comprise estimating a first agent's own willingness to pay for a product, for each of multiple first agents; estimating the first agent's influence on one or more of multiple second agents' willingness for purchasing the product, for each of the multiple first agents; estimating an effort to influence the first agent to take an action that would influence the one or more second agents in purchasing the product, for each of the multiple first agents; and based on at least the first agent's willingness to pay for the product, the first agent's influence, and the effort to influence the first agent, identifying simultaneously a price of the product for the first agent and an incentive for the first agent to take the action, that maximizes a profit of a seller of the product.

### CROSS-REFERENCE TO RELATED APPLICATIONS

This application is a continuation of U.S. Ser. No. 14/022,336, filed on Sep. 10, 2013, which claims the benefit of U.S. Provisional Application No. 61/840,731, filed on Jun. 28, 2013, entitled “DESIGNING PRICE INCENTIVES IN A NETWORK WITH SOCIAL INTERACTIONS”, the entire content and disclosure of each of which is incorporated herein by reference.

### FIELD

The present application relates generally to computers, and computer applications, and more particularly to providing incentives that guarantee influence using social network data.

### BACKGROUND

The recent ubiquity of social networks have revolutionized the way people interact and influence each other. The social networking platforms allows firms to collect unprecedented volumes of data about their customers, their buying behavior including their social interactions with other customers. The challenge that confronts every firm, from big to small, is how to process this data and turn it into actionable policies so as to improve their competitive advantage.

### BRIEF SUMMARY

A method for providing prices and incentives for a product, in one aspect, may comprise estimating a first agent's own willingness to pay for a product, for each of multiple first agents. The method may also comprise estimating the first agent's influence on one or more of multiple second agents' willingness for purchasing the product, for each of the multiple first agents. The method may further comprise estimating an effort to influence the first agent to take an action that would influence the one or more second agents in purchasing the product, for each of the multiple first agents. The method may further comprise, based on at least the first agent's willingness to pay for the product, the first agent's influence, and the effort to influence the first agent, identifying simultaneously a price of the product for the first agent and an incentive for the first agent to take the action, that maximizes a profit of a seller of the product.

A system for providing a price, in one aspect, may comprise a first estimator module operable to execute on a processor and further operable to estimate a first agent's own willingness to pay for a product, for each of multiple first agents. The first estimator module may be further operable to estimate the first agent's influence on one or more of multiple second agents' willingness for purchasing the product, for each of the multiple first agents. A second estimator module may be operable to execute on the processor and further operable to estimate an effort to influence the first agent to take an action that would influence the one or more second agents in purchasing the product, for each of the multiple first agents. An optimizer module may be operable to execute on the processor and further operable to identify simultaneously a price of the product for the first agent and an incentive for the first agent to take the action, that maximizes a profit of a seller of the product, based on at least the first agent's willingness to pay for the product, the first agent's influence, and the effort to influence the first agent.

A computer readable storage medium and/or device storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a block diagram illustrating a pricing method and components for providing differentiated prices and differentiated incentives in one embodiment of the present disclosure.

FIG. 2 is a diagram illustrating an example of incentivizing people to influence others to purchase, which leads to guaranteed profits.

FIG. 3 is a block diagram illustrating a pricing strategy and associated service that can be offered to a buyer in one embodiment of the present disclosure.

FIG. 4 illustrates the two-stage game optimization.

FIG. 5 shows an example plot of the optimal prices offered by the seller to the different agents under the discriminative and uniform pricing strategies with and without social interactions in one embodiment of the present disclosure.

FIG. 6 shows an example of centrality effect of losing money on an influential agent.

FIG. 7 shows value of incorporating incentives that guarantee influence in one embodiment of to present disclosure.

FIG. 8 shows an example of a symmetric graph with asymmetric incentives, with and without incentives.

FIG. 9 shows example of optimal prices for various network topologies.

FIG. 10 illustrates a schematic of an example computer or processing system that may implement a pricing system in one embodiment of the present disclosure.

### DETAILED DESCRIPTION

An embodiment of the present disclosure, a design of effective pricing strategies may be provided that improves profitability of a firm that sells indivisible goods or services to agents embedded in a social network.

In one aspect, a pricing strategy may include offering differential pricing and differential incentives for influencing based on social network data that guarantees influence in exchange of taking an action. Everyone (influencing agents) gets multiple prices (e.g., price and incentive). Thus, a price and incentive may be different for each person and is based on the person's activity on the social network and with a retailer. To receive the lower price, people must take an action that influences its neighbors more.

In one embodiment of the present disclosure, effort required to persuade an influencing agent to take an action may be computed from social network data, historical reviews and wall posts. Differentiated prices and incentives (Buy price+influence incentive) may be computed using social network data. An optimization model may be provided that includes a formulation that can identify prices and incentives simultaneously. The pricing strategy design of the present disclosure in one embodiment is a transparent method, e.g., it can be easily incorporate business rules.

A feature of the products or services considered in the present disclosure may be that they exhibit local positive externalities. This means people positively influence each other willingness-to-pay for an item which gets more valuable to a person if many more of his friends buy it. Examples of products with such effects may include, but are not limited to, smart phones, tablets, certain fashion items and cell phone plans. Such positive externalities may be more significant when new generation of products are introduced in the market and people use social networks as a way to accelerate their friends' awareness about the item.

A model may be developed that incorporates the positive social externalities between potential buyers and efficient algorithms may be designed to compute the optimal prices for the item to maximize the seller's profitability. In particular, a method may be provided for a systematic and automated way of finding the prices to offer to the agents based on their influence level so as to maximize the total profit of the seller.

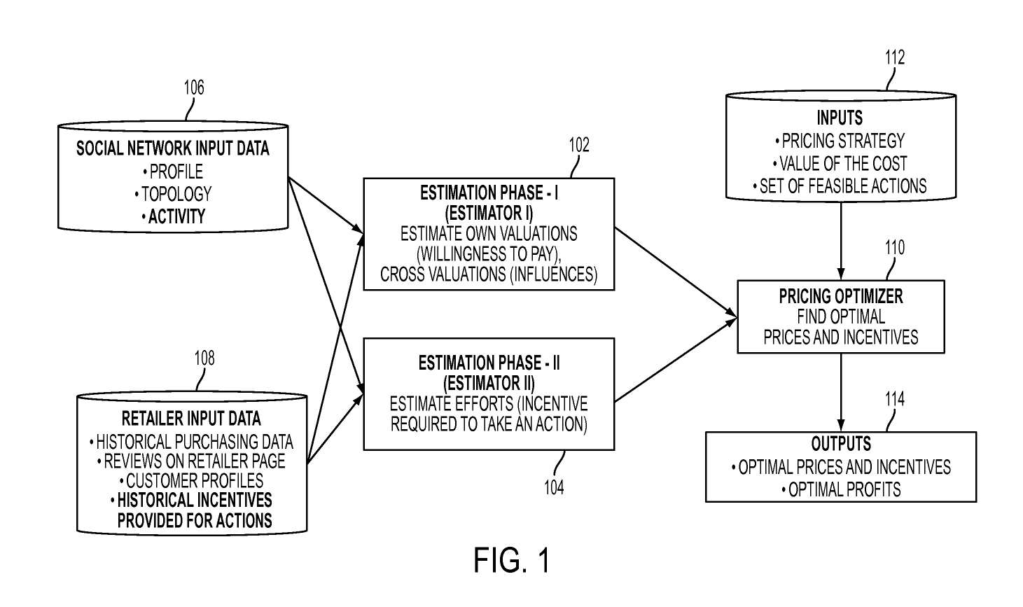

FIG. 1 is a block diagram illustrating a pricing method and components for providing differentiated prices and differentiated incentives in one embodiment of the present disclosure. In the present disclosure, the terminology “product” may refer to a good and/or a service.

Estimation phase-I at 102 estimates individual's (also referred to as first agent) own value or valuation (willingness to pay) for a product, and the individual's influence among the peers (also referred to as second agents) in a product category (also referred to as cross valuations), based on social network input data 106 and retailer input data 108. This estimation is performed for multiple individuals (first agents).

Social network input data 106 may comprise user profiles, topology, and activity. Topology refers to the structure of the network showing who is connected to whom. Activity refers to what people post and re-post on their walls in social networks and who they follow in social media such as in blogging sites. Influence in one embodiment of the present disclosure can be defined in multiple ways. For example, an agent's influence can be specified as the number of people who follow that agent; the number friends the agent has; how many times the messages the agent posts are liked and/or re-posted by the agent's friends on their walls.

Retailer input data 108 may comprise historical purchasing data (e.g., price paid for similar items), reviews on retailer page, customer profiles, and historical incentives provided to customers for actions to influence.

The interaction between seller and buyers may be viewed as a two-stage game where the seller first offers prices and the agents then choose whether to purchase the item or not at the offered prices. The utility of an agent may be captured using a linear additive valuation model wherein the total value for an agent in owning the item as the sum of the agent's own value as well as the (positive) influence from the agent's friends who own the item.

After purchasing an item, it is sometimes not entirely natural to influence friends about the product unless one takes some effort to do so. This for example could be writing a review, endorsing the item on their wall, blogging about the item or at the very least announcing that they have purchased the item.

Estimation phase-II at 104 estimates efforts for each of the individuals (first agents), which is the incentive required to make the individual (first agent) take an action to influence one or more peers (second agents) to purchase the product. The phase-II estimation also uses the social network input data 106 and the retailer input data 108.

The computation at phase-II 104 allows for the seller to design both prices and incentives so as to maximize profitability while aiming to guarantee influence by soliciting influence actions in return for the incentives. The seller ensures the influence among the agents by offering a price and a discount (incentive) to each buyer (first agent). The buyer can then decide between several options: (i) not buy the item, (ii) buy the item at the full price or (iii) buy the item and claim a portion of the discount (incentive) in return for influence actions specified by the seller. In this last alternative, the agent receives a small discount (or prize) in exchange for a simple action such as liking the product and a more significant discount (or prize) by taking a time-consuming action such as writing a detailed review thereby influencing friends by varying degrees in the respective cases. The utility model of an agent takes an additional input parameter in this setting. This is referred to as the influence cost for an agent which is the utility value of the effort it takes for an agent to influence his neighbors. As shown at 104, this parameter can be estimated from historical data using the intensity of online activity for past purchases, the number of reviews written, the corresponding incentives needed and other data from cookies or like web trail data. With this more general pricing setting, the seller can ensure the influence among the agents so that the network externalities effects are guaranteed to occur.

A pricing optimizer 110 (e.g., a static optimization model) may be built to compute optimal price incentives and corresponding profit. The pricing optimizer 110 takes as input the estimated valuations and cross valuations determined at 102, and the estimated efforts computed at 104. The pricing optimizer 110 also receives as additional input 112, value of the cost, a set of feasible actions, and a pricing strategy. Based on the input, the pricing optimizer 110's optimization formulation is solved to determine an optimal price and incentive for each of the first agents and corresponding profit. Outputs 114 comprising the optimal prices and incentives, and optimal profits may be generated. The pricing optimizer 110 computes the optimal prices and incentives for each agent and the corresponding profits using the valuation, cross-valuation (influence) and effort information for all agents computed at 102 and 104, and the cost of the product so that it is in accordance with a planned pricing strategy and business constraints.

The estimations in phase I and II may be implemented as computer executable modules that run on a computer processor. Likewise, the pricing optimizer 110 may be part of a computer executable component that runs on a computer processor.

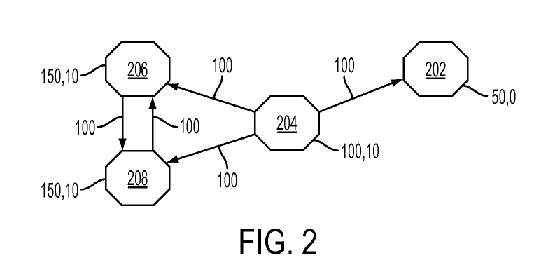

FIG. 2 is a diagram illustrating an example scenario for incentivizing people to influence others to purchase, which leads to guaranteed profits. An unrealistic view assumes that consumers always influence their peers as long as they purchase the item. Consequently, the solutions and the corresponding profits are not guaranteed and provide only theoretical bounds. In one embodiment of the present disclosure, the retailer can enforce buyers to impart their influence on neighbors. Therefore, the obtained profits are not an upper bound anymore but instead are guaranteed. A node represents (202, 204, 206, 208) a potential buyer (an agent). The pair of numbers shown next to each node represents that agent's own value and effort to make the agent influence a peer. The arrow directions indicate influence that the agent has on a peer. Thus, for example, agent at 202 is willing to pay 50 units for a given product, and requires 0 units as effort, since this agent does not have an influence on other (no outgoing directional arrow from this node). Agent at 204 has 100 units as a value the agent is willing to pay for the given product, require 10 units as effort in order to incentivize the agent 204 to influence others to buy, and has influence on agents 202, 206 and 208 (as shown by the outgoing arrows from node 204). Agent at 206 has 150 units as a value the agent is willing to pay for the given product, requires 10 units as effort in order to incentivize the agent 206 to influence others to buy, and has influence on agent 208. Agent at 208 has 150 units as a value the agent is willing to pay for the given product, requires 10 units as effort in order to incentivize the agent 208 to influence others to buy, and has influence on agent 206. Consider that the cost of manufacturing the product is 50 units, and the ticket price is 200 units. In this scenario, pricing strategy that does not incorporate the effort to influence others may produce 300 units while a pricing strategy that incorporates the effort to influence according to the present disclosure may produce profit of 440 units, as a result of incentivizing the influencer by paying the amount of effort in return for influencing the others to buy the product.

The approach of the present disclosure may rely on a combination of data analytics and optimization. The approach may achieve guaranteed profits while still taking into account social interactions; Design multiple prices for each buyer by proposing a strategic choice model; Can easily incorporate business rules and other constraints in the optimization model; and Generalize many instances as special cases.

The resulting prices take into account network effects of influence and incentives that can guarantee influence amongst neighbors (friends or followers), and provide some guarantee on the profits. The approach of the present disclosure in one embodiment can be used as a means of targeted advertizing so that people are aware of a new product and can be used for a wide range of products/services where social interactions data is available. In one aspect, both incentives and prices are optimized together.

The ubiquity of social networks allows firms to collect vast amount of data on the structure of the network as well as on the social interactions between the different agents. A model of the present disclosure in one embodiment, where a retailer sells a good to consumers embedded in a social network. It may be assumed that the retailer has access to the data about the social interactions between the various agents. A method is provided that designs prices and incentives to increase the retailer's profitability where the consumers choose whether to buy the item at the offered price, and whether to influence other agents with the offered incentives. The method can identify prices and incentives simultaneously and is flexible enough to incorporate a variety of business rules that may exist in practice. The method incorporates social interactions and incentives that guarantee influence.

In another aspect, a service may be provided for passively estimating the following for each person using social network data feed, past reviews, historical purchases with a retailer and their profile: value for certain products; their influence amongst their peers for that product category; and the effort that it takes from them to influence such as writing a review or endorsing a product.

Using the information on value, influence and effort, the retailer's pricing strategy and cost of the product, the service of the present disclosure may provide: multiple prices and/or incentives each buyer gets in exchange for buying the product as well as taking the action to influence its peers (e.g., endorse, wall post, review, etc.); and total guaranteed profit from sales using the proposed prices.

For example, suppose that a new product enters the market. The retailer can then use the service of the present disclosure to learn each person value for the item as well as the effort needed for that person to influence his peers. Using the service of the present disclosure, the retailer can also decide the prices to offer to each person to (a) buy the item (that depends on how another influences him); and, (b) influence his peers; to maximize overall profitability.

There may be different pricing strategies offered by a seller. For instance, in fully discriminative prices pricing strategy, the retailer can offer different prices to each potential buyer, e.g., by sending coupons. This strategy may be useful as it yields an upper-bound on the profits. Another pricing strategy may provide a uniform single price, e.g., single price across the network. An intermediate case (comprising a set of k values) is yet another pricing strategy, which can be applied to geographical locations (e.g., discounting for transportation costs, etc) and can represent the loyalty of the customers (e.g., premium members).

A system and a method of the present disclosure in one embodiment offer a price and a discount to each individual on the social network to buy the item. Beyond this the seller can restrict

the prices to satisfy certain properties. For example, everyone should get the same prices and discounts; prices can be different for people in a fan club but same for the remaining people; they can be different for everybody, etc. These price based business rules are referred to as the pricing strategy chosen by the seller. A method (e.g., referred to in the present disclosure as Zi-MIP) allows one to place these business rules as constraints through the specification of the set P of prices.

A system and a method for pricing strategy in one embodiment of the present disclosure guarantees influence: that is, each buyer is offered multiple prices in exchange of taking some action (endorse, review, wall post, recommendation, etc.).

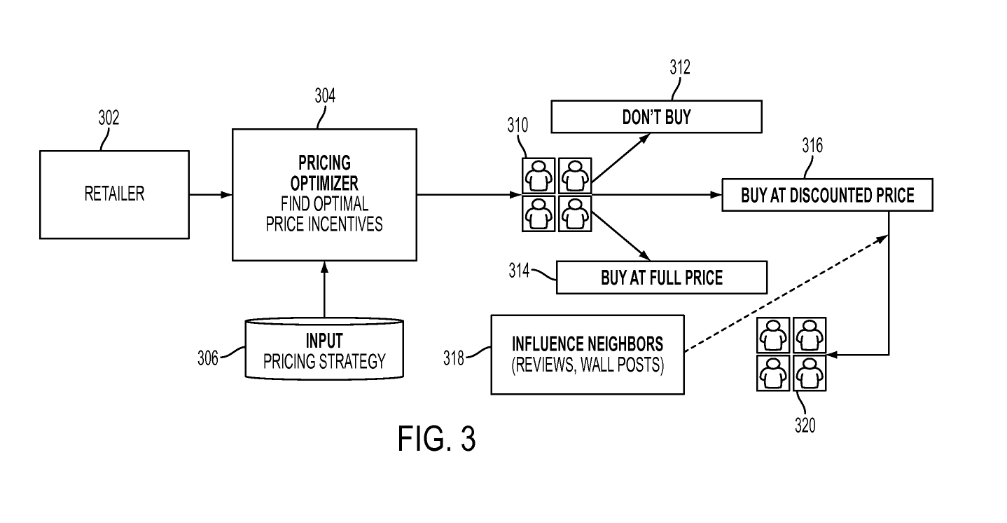

FIG. 3 is a block diagram illustrating a pricing strategy and associated service that can be offered to a buyer in one embodiment of the present disclosure. A retailer 302 may employ a pricing optimizer 304 of the present disclosure to offer prices of a product to potential buyers 310. Briefly, a pricing methodology of the present disclosure may be implemented as a computer software or module executable on a processor. Such computer software may comprise in one embodiment, a user interface module (e.g., a graphical user interface module (GUI)) for interacting with a user, e.g., retailer, for inputting or configuring parameters and/or viewing outputs from the pricing optimizer 304. The pricing optimizer 304 takes as input, the retailer's pricing strategy 306 (e.g., business rules or constraints on pricing), and estimations comprising what each of the potential buyers 310 is willing to pay for the product (valuation), an influence factor that each of the potential buyers 310 has on one or more other potential buyers 320, and effort factor that is required for each of the potential buyers 310 to act to influence (actually perform one or more acts for influencing other buyers 320). The pricing optimizer 304 finds optimal price and incentive for each of the potential buyers 310 that maximize the retailer's 302 business goal, for example, the profitability. Given the price and incentive, each of the buyers 310 may be given an option to not buy at all 312, buy at a discount (i.e., at the price and incentive) 316 and act to influence, or to buy at full price 314. A buyer 310 may choose one of the options. If a buyer 310 chooses to buy at discounted price, the buyer 310 would perform an influencing act 318, e.g., post positive reviews, wall posts, endorse the product and/or perform another promotional activity.

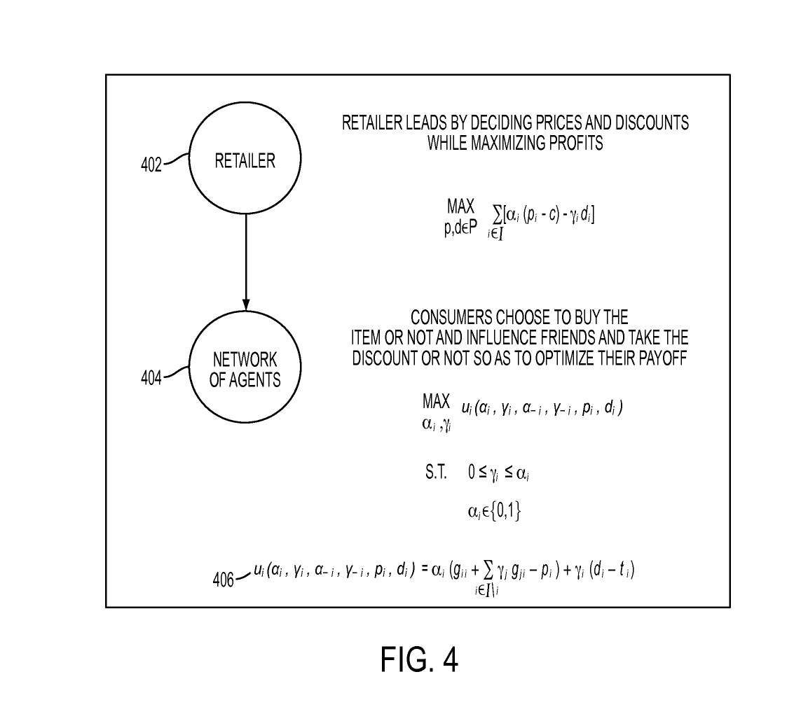

In one embodiment, the price optimizer 314 of the present disclosure may be formulated as a two-stage game optimization problem. FIG. 4 illustrates the two-stage game optimization. In the first stage 402, a retailer leads by deciding prices while maximizing profits. In the second stage 404, consumers collectively maximize utilities, by choosing to buy or not to buy the item so as to optimize their payoff. The terms presented in formulations are described below.

A utility model 406 may comprise two prices. D represents the sets of buyers that purchase at full price. F represents the sets of buyers that purchase at discounted price respectively. The formulation may be a non-convex problem but proposed mixed integer linear program that optimally solves the problem, which under special instances, may reduce to a linear program.

The following paragraphs describe a pricing model and methodology of the present disclosure in one embodiment in greater detail.

Model

Consider a firm selling an indivisible product to N agents denoted by the set |={1, . . . , N} embedded in a social network. We denote the value interaction matrix for this product by G, where the element gⱼᵢ represents the marginal increase in value that agent i obtains by owning the product when agent j owns also the product. In particular, gᵢᵢ is the marginal value that agent i derives from himself by owning the product. If agent j does not influence agent i, then gⱼᵢ=0.

Assumption 1. We make the following assumptions about G:
a. Only positive influences occur among the agents in the network, i.e., that gⱼᵢ≧0 for all i, j.
b. The firm and the agents have perfect knowledge of the network externalities, i.e., everyone knows G.

Let the vector pεP denote the prices offered by the firm for the indivisible product. In particular, pᵢεP (real number) is the i^{th} element of the vector p and represents the price offered to agent i by the seller. Here, P is assumed to be a polyhedral set that represents the feasible pricing strategies of the firm, which possibly includes several business constraints on prices and on network segmentation. For example, the firm can adopt a discriminative pricing strategy where each agent may potentially receive a different price. In this case, P=P^{N}. In addition, one can restrict the values of these prices to lie between p_{L} and p_{U}(≧p_{L}), i.e., P={pεP^{N}|p_{L}≦pᵢ≦p_{U} ∀i}. A common pricing strategy is to adopt a single uniform price for all the agents across the network. Here, P={pεP^{N}|pᵢ= p̅∀i, p̅εP}. In a similar fashion, depending on the application, the firm can select some appropriate business constraints to impose on the pricing strategy. Finally, P can also incorporate specific constraints on the network segmentation. For example, motivated by business practices, a particular segment of agents should be offered the same price or special members (loyal customers) need to receive a lower price than regular customers.

In the present disclosure in one embodiment, a general optimal pricing method is developed for the firm that incorporates the different business rules as constraints. Before we mathematically formulate the problems of the potential buyers and the firm, we summarize our assumptions about them below.

Assumption 2. We assume the following about each agent iε| in the network:
a. Each agent has a linear additive form of the utility as described below in (1).
b. Each agent is assumed to be rational and a utility maximizer.
c. Each agent can buy at most one unit of the item and either fully purchases the item or does not purchase it at all.
d. If the utility of an agent is zero, the tie is broken assuming this agent buys the item.

Assumption 3. We assume that the seller is a profit maximizer as described below in (3) and has a linear manufacturing cost.

For a given set of prices chosen by the seller, the agents in the network aim to collectively maximize their utility from purchasing the item. We capture the linear additive valuation model of an agent by assuming that the total value for owning the item is the sum of the agent's own valuation and the valuation derived from the (positive) influences of the agent's friends who own the item. In particular, the utility of agent i is given by:

$${u}_{i} ( {α}_{i} , {α}_{- 1} , {p}_{i} ) = {α}_{i} [ {g}_{ii} + {\sum }_{j ∈ \vert \backslash i} {α}_{j} {g}_{ji} - {p}_{i} ] , \qquad ( 1 )$$

where αᵢε{0,1} is a binary variable that represents the purchasing decision of agent i and α₋₁ represents the vector of purchasing decisions of all the agents but i in the network. If αᵢ=1, agent i purchases the item and derives a utility equal to gᵢᵢ+Σ_{jε|\i}αⱼgⱼᵢ−pᵢ from owning the item and if, on the other hand, αᵢ=0, the agent does not purchase the item and derives zero utility. The utility maximization problem of agent i can then be written as follows:

$${max}_{{α}_{i} ∈ \{ 0 , 1 \}} {u}_{i} ( {α}_{i} , {α}_{- i} , {p}_{i} ) . \qquad ( 2 )$$

The profit maximizing problem of the seller is given by:

$${max}_{p ∈ P} {\sum }_{i ∈ \vert} {α}_{i} ( {p}_{i} - c ) , \qquad ( 3 )$$

where αᵢ's are the purchasing decisions of the agents obtained from the utility maximization subproblem (2) and c is the unit manufacturing cost of the item. If agent i decides to buy the product at the offered price pᵢ, αᵢ is equal to 1 and the firm incurs a profit of pᵢ−c. If agent i decides not to purchase the item, it incurs zero profit to the seller. The firm designs the prices to offer to the different agents depending on the pricing strategy P employed.

In one embodiment of the present disclosure, the entire problem may be viewed as a two-stage Stackelberg game, referred also to as the pricing-purchasing game. First, the seller leads the game by choosing the vector of prices p to be offered to the potential buyers. Second, the agents follow by deciding whether or not to purchase the item at the offered prices. In other words, the firm sets the prices pεP and the network of agents collectively follow with their decisions, αᵢ∀iε|. We are interested in subgame perfect equilibria of this two-stage pricing-purchasing game. For a fixed vector of prices offered by the seller, the equilibria of the second stage game, referred to as the purchasing equilibria are defined as follows:

$${α}_{i}^{*} ∈ arg {max}_{{α}_{i} ∈ \{ 0 , 1 \}} {u}_{i} ( {α}_{i} , {α}_{- i}^{*} , {p}_{i} ) ∀ i ∈ \vert . \qquad ( 4 )$$

This definition is similar to the consumption equilibria for a divisible item (or service). However, in the present disclosure in one embodiment, the decision variables αᵢ are restricted to be binary so that agents cannot buy fractional amounts of the item and have to either buy it fully or not to buy it at all.

We also note that the overall two-stage problem is non-linear and non-convex as it includes terms of the form αᵢpᵢ in the seller's objective function and αᵢαⱼ in the objective functions of the agents which we will see soon appears as constraints in the seller's problem. In addition, the discrete nature of the purchasing decisions makes it even more complicated in that we are working with a non-convex integer program. Therefore, one cannot directly apply tractable convex optimization methods to solve the problem to optimality. In the next section, we start by considering the second stage purchasing game and show the existence of an equilibrium such as in Eq. (4), for any given vector of prices. We then characterize the equilibria by a set of constraints for any price vector. Below in MIP formulation description, we use this characterization to formulate the optimal pricing problem as a MIP.

Purchasing Equilibria

We consider the second stage purchasing game and show the existence of a pure Nash equilibrium (PNE) strategy, given any vector of prices p specified by the seller. We observe that there could be multiple pure Nash equilibria for this game but we characterize all these equilibria through a system of constraints using duality theory.

Existence of the Purchasing Equilibria

The existence of a PNE for the second stage game is summarized in the following theorem.

Theorem 1. The second stage game has at least one pure Nash equilibrium for any given vector of prices p chosen by the seller.

We note that Theorem 1 guarantees the existence of a PNE but not necessarily its uniqueness. Consider the following example in which two distinct PNE's arise. Assume a network with two symmetric agents that mutually influence one another: g₁₁=g₂₂=2 and g₂₁=g₁₂=1. Consider the given price vector: p₁=p₂=2.5. In this case, we have two PNE's: buy-buy and no buy-no buy. In other words, if player 1 buys, player 2 should buy but if player 1 does not buy, player 2 will not either. Therefore, uniqueness is not guaranteed.

A common assumption in games with multiple equilibria is that the Nash equilibrium that is actually played relies on the presence of some mechanism or process that leads the agents to play this particular outcome. We impose a similar assumption in our setting and assume that the seller can identify some simple (low cost) strategies to guide the players to his preferred Nash equilibrium. In the above example, reducing the price for one of the players to p=2−ε for a small ε>0 is enough to guarantee the preferred buy-buy equilibrium and discard the undesired no buy-no buy equilibrium. A secondary seeding algorithm called the least cost influence problem is proposed that minimizes the total cost of incentives offered to all the players in order to achieve the preferred solution in their setting. The nature of the first stage game induces the preferred equilibrium buy-buy and hence a similar secondary mechanism may be potentially required.

Characterization of the Purchasing Equilibria

The next step is to characterize the purchasing equilibria as a function of the prices. In other words, we would like to characterize the functions αᵢ(p)∀iε|. This will allow us to reduce the two-stage problem to a single optimization formulation, where the only variables are the prices. In our setting, a closed form expression for αᵢ(p) is not straightforward. Instead, by using duality theory, we characterize the set of constraints the equilibria should satisfy for any given vector of prices. We begin by making the following observation regarding the utility maximization problem of any agent.

Observation 1. Given a vector of prices p, let us consider the subproblem (2) for agent i. If the decisions of the other agents α₋₁ are given, the problem of agent i has a tight linear programming (LP) relaxation.

The sub-problem faced by agent i happens to be an assignment problem for fixed values of p and α₋₁. More specifically, let us consider the LP obtained by the continuous relaxation of the binary constraint αᵢε{0,1} to 0≦αᵢ≦1. One can view this LP as a relaxation purchasing game where agents can purchase fractional amounts of the item and therefore adopt mixed strategies. If the quantity (gᵢᵢ+Σ_{jε|†i}αⱼgⱼᵢ−pᵢ) (which is exactly known since p and α₋₁ are given) is positive, α*ᵢ=1 and if the quantity is negative, α*ᵢ=0. If the quantity is equal to zero, α*ᵢ can be any number in [0,1] so that the agent is indifferent between buying and not buying the item. Therefore, the LP relaxation of the subproblem of agent i for fixed values of p and α₋₁ is tight, meaning that all the extreme points are integer. Equivalently, for any feasible fractional solution, one can find an integral solution with at least the same objective.

Observation 1 allows us to transform the relaxation of subproblem (2) for agent i into a set of constraints by using duality theory of linear programming. More specifically, these constraints comprise of primal feasibility, dual feasibility and strong duality conditions. In the case of subproblem (2) for agent i, the constraints can be written as follows:

$$\begin{matrix}Primal feasiblity \text{:} 0 \leq {α}_{i} \leq 1 & ( 5 ) \\ Dual feasibility \text{:} {y}_{i} \geq {g}_{ii} + {\sum }_{j ∈ \vert \backslash i} {α}_{j} {g}_{ji} - {p}_{i} & ( 6 ) \\ {y}_{i} \geq 0 & ( 7 ) \\ Strong duality \text{:} {y}_{i} = {α}_{i} ( {g}_{ii} + {\sum }_{j ∈ \vert \backslash i} {α}_{j} {g}_{ji} - {p}_{i} ) & ( 8 )\end{matrix}$$

Here, the variable yᵢ represents the dual variable of subproblem (2) for agent i. Combining the above constraints (5)-(8) for all the agents iε| characterizes all the equilibria (mixed and pure) of the second stage game as a function of the prices. In order to restrict our attention to the pure Nash equilibria (that the existence is guaranteed by theorem 1), one can impose αᵢε{0,1}∀i. Observe that this characterization has reduced N+1 interconnected optimization problems to be compactly written as a single optimization formulation. We note that the number of variables increases by N as we add a dual continuous variable for each agent's subproblem.

Optimal Pricing: MIP Formulation

In one embodiment of the present disclosure, we use the existence and characterization of PNE to transform the two-stage optimal pricing problem into a single optimization formulation. This formulation happens to be a non-convex integer program but depicts some interesting properties. We then reformulate the problem to arrive at a MIP with linear constraints.

We next formulate the optimal pricing problem faced by the seller (denoted by problem Z) by incorporating the second stage PNE characterized by the set of constraints (5)-(8) for each agent. The class of optimization problems with equilibrium constraints is referred to as MPEC (Mathematical Program with Equilibrium Constraints). The equilibrium constraints in the present disclosure in one embodiment include constraints (6)-(8) and αᵢε{0,1} instead of constraint (5) for all agents to restrict to the pure Nash equilibria. The formulation is given by:

$${max}_{{p ∈ P}_{y , α} } {\sum }_{i ∈ \vert} {α}_{i} ( {p}_{i} - c ) \\ s . t . \\ \begin{matrix}{y}_{i} & = {α}_{i} ( {g}_{ii} + {\sum }_{j ∈ \vert \backslash i} {α}_{j} {g}_{ji} - {p}_{i} ) \\ {y}_{i} & \geq {g}_{ii} + {\sum }_{j ∈ \vert \backslash i} {α}_{j} {g}_{ji} - {p}_{i} \\ {y}_{i} & \geq 0 \\ {α}_{i} & ∈ \{ 0 , 1 \}\end{matrix} \} ∀ i ∈ \vert \qquad ( Z )$$

In addition to the presence of binary variables, one can see that the above optimization problem is non-linear and non-convex as it includes terms of the form αᵢαⱼ and αᵢpᵢ. Therefore, problem Z is not easily solvable by commercially available solvers. We next prove the following interesting tightness result of problem Z that allows us to view the problem as a non-convex continuous, instead of an integer problem. This is not of immediate consequence in this section but provides insight to one of our main results presented in theorem 2.

Proposition 1. Problem Z Admits a Tight Continuous Relaxation.

We next show that by introducing a few additional continuous variables, one can reformulate problem Z into an equivalent MIP formulation that has a linear objective with linear constraints and the same number of binary variables. We first define the following additional variables:

zᵢ=αᵢpᵢ ∀iε|

xᵢⱼ=αᵢαⱼ ∀j>i where i,jε|.

By using the binary nature of the variables and adding certain linear constraints, one can replace all the non-linear terms in problem Z that is now equivalent to the following MIP formulation denoted by Z-MIP:

$$\begin{matrix}{max}_{{p ∈ P}_{y , z , x , α}} {\sum }_{i ∈ \vert} ( {z}_{i} - c {α}_{i} ) \\ s . t . \\ \begin{matrix}{y}_{i} & = {α}_{i} {g}_{ii} + {\sum }_{j ∈ \vert \backslash i} {g}_{ji} {x}_{ji} - {z}_{i} \\ {y}_{i} & \geq {g}_{ii} + {\sum }_{j ∈ \vert \backslash i} {α}_{j} {g}_{ji} - {p}_{i} \\ {y}_{i} & \geq 0\end{matrix} \} ∀ i ∈ \vert & ( Z \text{-} MIP ) \\ \begin{matrix}{z}_{i} & \geq 0 \\ {z}_{i} & \leq {p}_{i} \\ {z}_{i} & \leq {α}_{i} {p}^{ma x} \\ {z}_{i} & \geq {p}_{i} - ( 1 - {α}_{i} ) {p}^{ma x}\end{matrix} \} ∀ i ∈ \vert & ( 10 ) \\ \begin{matrix}{x}_{ij} & \geq 0 \\ {x}_{ij} & \leq {α}_{i} \\ {x}_{ij} & \leq {α}_{j} \\ {x}_{ij} & \geq {α}_{i} + {α}_{j} - 1 \\ {x}_{ij} & = {x}_{ji}\end{matrix} \} ∀ j > i where i , j ∈ \vert & ( 11 ) \\ {α}_{i} ∈ \{ 0 , 1 \} \\ ∀ i ∈ \vert & ( 12 )\end{matrix}$$

In the above formulation, p^{max} denotes the maximal price allowed and is typically known from the context. For example, one can take: p^{max}=maxᵢ{gᵢᵢ+Σ_{j≠i}gⱼᵢ} without affecting the problem at all, since no agent would pay a price beyond that value. The set of constraints (10) aims to guarantee the definition of the variable zᵢ, whereas the set of constraints (11) ensures the correctness of the variable xᵢⱼ. One can note that in the above Z-MIP formulation, we have a total of

$$\frac{{N}^{2}}{2} + 3.5 N$$

variables (4N for α, p, y and z and

$$\frac{N ( N - 1 )}{2}$$

for x) but only N of them are binary, while the remaining are all continuous.

We conclude that the problem of designing prices for selling an indivisible item to agents embedded in a social network can be formulated as a MIP that is equivalent to the two-stage non-convex IP game we started with. As a result, one can easily incorporate various business constraints such as pricing policies, market segmentation, inter-buyers price constraints, just to name a few. In other words, this formulation can be viewed as an operational tool to solve the optimal pricing problem of the seller. This is in contrast to previous approaches that proposed tailored algorithms for the problem where one cannot easily incorporate business rules. However, solving a MIP may not be very scalable. If the size of the network is not very large, one can still solve it using commercially available MIP solvers. Moreover, it is possible to solve the problem off-line (before launching a new product for example) so that the running time might not be of first importance. Potentially, one can also consider network clustering methods to aggregate or coalesce several nodes to a single virtual agent in order to reduce the scale of the network. If the size of the network is very large, one needs to find more efficient methods to solve the Z-MIP problem. In the next section, we derive efficient methods (polynomial in the number of agents) to solve it to optimality for two different but popular pricing strategies.

Efficient Algorithms

Discriminative Prices

We consider the most general pricing strategy where the firm offers discriminative prices that potentially differ for each agent, depending on his influence in the network. In particular, P=P^{N} in problem Z-MIP. This scenario is of interest in various practical settings where the seller gathers the purchasing history of each potential buyer, his geographical location as well as other attributes or features. It can also be used by the seller to understand who are the influential agents in the network and what is the maximal profit he can potentially achieve if he were to discriminate prices at the individual level. The prices can then be implemented by setting a ticket price that is the same for all the agents and sending out coupons with discriminative discounts to the potential buyers in the network. It often occurs that people receive different deals for the same item depending on the loyalty class, purchase history and store location. A very small number of highly influential people (e.g., certified bloggers) also receive the item for free or at a very low price. The method of the present disclosure in one embodiment may provide a systematic and automated way of finding the prices (equivalently, the discounts) to offer to the agents embedded in a social network based on their influence so as to maximize the total profit of the seller.

Solving the Z-MIP problem presented in the previous section using an optimization solver may be not practical for a very large scale network. We next show that solving the LP relaxation of the Z-MIP problem yields the desired optimal integer solution. Consequently, one can solve the problem efficiently (polynomial in the number of agents) and obtain an optimal solution even for large scale networks. This result is very interesting because the linearization of problem Z was possible only under the assumption of integrality of the decision variables. In other words, in order to reformulate problem Z into problem Z-MIP, the binary restriction was needed. It is therefore possible that because of variables zᵢ and xᵢⱼ, new fractional solutions that cannot be practically implemented are introduced. However, the following theorem shows that the optimal solutions of Z-MIP can be identified using its relaxation.

Theorem 2. The optimal discriminative pricing solution of the Z-MIP problem can be obtained efficiently (polynomial in the number of agents). In particular, problem Z-MIP with P=P^{N} admits a tight LP relaxation.

We not only show that the LP relaxation is tight but also provide a constructive method of rounding the fractional LP solution to obtain an integer solution that is as good in terms of the profit. One can employ this constructive method or use a method like simplex to arrive at the optimal extreme points which we know are integer. Here forth, when we refer to the solution of Z-MIP, we refer to its integer optimal solution only.

The result of theorem 2 suggests an efficient method to solve the problem that we formulated as a two stage non-convex integer program. The LP based method inherits all the complexity properties of linear programming and is thus scalable and applicable to large scale networks. Below, we consider adding constraints on the pricing strategy by investigating the case of designing a single uniform price across the network.

Uniform Price

We consider the case where the seller offers a uniform price across the network while incorporating the effects of social interactions. This scenario may arise when the firm may not want to price discriminate due to fairness or other reasons and prefers to offer a uniform price. It is also interesting to compare the total profits achieved by this pricing strategy to the case where discriminative prices are used. In particular, one can quantify how much the seller is losing by working with a uniform pricing strategy. We observe that a similar result to theorem 2 for the uniform pricing case does not hold. In other words, by adding the linear uniform price constraint: p₁=p₂= . . . =p_{N} to the Z-MIP formulation as an additional business rule, the corresponding LP relaxation is no longer tight and we obtain fractional solutions that cannot be implemented in practice. Geometrically, this means that incorporating such a constraint in the Z-MIP formulation is equivalent to add a cut that violates the integrality of the extreme points of the feasible region. Therefore, we propose an alternative approach that solves the problem optimally by an efficient algorithm (polynomial in the number of agents) that is based on iteratively solving the relaxed Z-MIP, which is an LP. We summarize this result in the following theorem.

Theorem 3. The optimal solution of the Z-MIP problem for the case of a single uniform price can be obtained efficiently (polynomial in the number of agents) by applying algorithm 1.

Algorithm 1. Procedure for finding the uniform optimal price

Input: c, N and G

Assumption: gⱼᵢ≧0 ∀i, jε|

Procedure
1. Set the iteration number to t=1, solve the relaxed Z-MIP (an LP) and obtain the vector of discriminative prices p⁽¹⁾.
2. Find the minimal discriminative price pₘᵢₙ^{(t)}=min_{iε|}pᵢ^{(t)} and evaluate the objective function Π^{(t)} with pᵢ=pₘᵢₙ^{(t)} ∀iε| using formula (26).
3. Remove all the nodes with the minimal discriminative price from the network (including all their edges). If there are no more agents in the network, go to step 5. If not, go to step 4.
4. Re-solve the relaxed Z-MIP for the new reduced network and denote the output by p^{(t+1)}. Set t:=t+1 and go to step 2.
5. The optimal uniform price is equal to pₘᵢₙ⁽ⁱ⁾, where \hat{t}=argmaxΠ^{(t)} i.e., the price that yields the larger profits.

We propose a method that iteratively solves the LP relaxation for discriminative prices to arrive at the optimal uniform price. The details of this procedure are summarized in algorithm 1. We show its termination in finite time and prove its correctness by showing that it yields the optimal solution of the uniform pricing problem (in polynomial complexity). At a high level, the procedure in algorithm 1 iteratively reduces the size of the network by eliminating agents with low valuations (at least one per iteration). As a result, it suffices for one to consider only a finite selection of price values to identify the optimal uniform price.

Price-Incentives to Guarantee Influence

In the above description, we have assumed that consumers always influence their peers as long as they purchase the item. This assumption is not realistic in many practical settings. Indeed, after purchasing an item, it is sometimes not entirely natural to influence friends about the product unless one takes some effort to do so. This, for example, could be by writing a review, endorsing the item on their wall, blogging about the item or at the very least announcing the purchase.

Consider a setting where the seller offers both a price and a discount (also referred to as an incentive) to each agent in the network. Each agent can then decide whether to buy the item or not. If the agent decides to purchase the item, he can claim a fraction of the discount offered by the seller in return for influence actions. These can include liking the product or a wall post in an online social media platform or writing a review so that these actions can be digitally tracked by the seller. The agent receives a small discount in exchange for a simple action such as liking the product and a more significant discount by taking a time-consuming action such as writing a detailed review. For example, online booking agencies request reviews of booked hotels on their website in return for certain loyalty benefits. Using such a model, the seller can now ensure the influence among the agents so that the network externalities effects are guaranteed to occur. In particular, the profits obtained through the optimization are guaranteed for the seller since each agent claims the discounted price as soon as the influence action is taken. In methodologies where externalities are assumed to always occur, the actual profits may be far from the value predicted by the optimization. We now extend our model and results to this more general setting where the seller can design price-incentives to guarantee social influence.

We consider a model with a continuum of actions to influence ones' neighbors. Let tᵢ≧0 denote the utility equivalent of the maximal effort needed by agent i to claim the entire discount offered by the seller. If agent i decides to purchase the item, we assume that γᵢtᵢ is the effort required by agent i to claim a fraction γᵢ of the discount, where 0≦γᵢ≦1. We view tᵢ as the influence cost for agent i and the variable γᵢ as the influence intensity chosen by agent i. The parameter tᵢ can be estimated from historical data using the intensity of online activity for past purchases, the number of reviews written, the corresponding incentives needed and data from cookies. For a given set of prices p and discounts d chosen by the seller, we extend the utility function of agent i in Eq. (1) as follows:

$${u}_{i} ( {α}_{i} , {γ}_{i} , {α}_{- i} , {γ}_{- i} , {p}_{i} , {d}_{i} ) = {α}_{i} ( {g}_{ii} + {\sum }_{j ∈ \vert \backslash i} {γ}_{j} {g}_{ji} - {p}_{i} ) + {γ}_{i} ( {d}_{i} - {t}_{i} ) , \qquad ( 13 )$$

where γᵢ≦αᵢ and αᵢ is the binary purchasing decision of agent i. So, if agent i does not purchase the item, αᵢ=0 and γᵢ=0 as well. But if agent i purchases the item, then αᵢ=1 and γᵢ can be any number in [0,1] as chosen by agent i. Here, α₋₁ and γ₋₁ are the decisions of all the other agents but i. Similarly to problem (2), the utility maximization problem for agent i can be written as follows:

$${max}_{{p , d ∈ P}_{y , w , α , γ }} {\sum }_{i ∈ \vert} [ {α}_{i} ( {p}_{i} - c ) - {γ}_{i} {d}_{i} ] \\ s . t . constraints - , {α}_{i} ∈ \{ 0 , 1 \} ∀ i ∈ \vert \qquad ( Zi )$$

In a similar way as problem (3), the seller's profit maximization problem can be written as:

$${max}_{{α}_{i} , {γ}_{i}} {u}_{i} ( {α}_{i} , {γ}_{i} , {α}_{- i} , {γ}_{- i} , {p}_{i} , {d}_{i} ) \\ s . t . 0 \leq {γ}_{i} \leq {α}_{i} \\ {α}_{i} ∈ \{ 0 , 1 \} \qquad ( 14 )$$

Here, the decision variables of the seller are p and d which are two vector of prices and discounts with an element for each agent in the network. These vectors can be chosen according to different pricing strategies. For example, one can consider a fully discriminative or a fully uniform pricing strategy or more generally, an hybrid model where the regular price is uniform across the network (pᵢ=pⱼ) but the discounts are tailored to the various agents. This hybrid setting corresponds to a common practice of online sellers that offer a standard posted price for the item but design personalized discounts for different classes of customers that are sent via e-mail coupons. Similarly to the previous setting, one can incorporate various polyhedral business rules on prices, discounts and constraints on network segmentation. The variables αᵢ and γᵢ are decided according to each agent's utility maximization problem given in (14). If agent i decides to buy the product, then the seller incurs a profit of pᵢ−γᵢdᵢ−c.

In the special case where αᵢ=γᵢ and tᵢ=0 ∀iε|, we recover the previous model where the seller offers a single price to each agent and any buyer is assumed to always influence his peers. In addition, by adding the constraint γᵢε{0,1} we have an interesting setting where each agent can only buy at two different prices: a full price pᵢ that does not require any action and a discounted price pᵢ−dᵢ that requires some action to influence. One can easily extend the model to more than two prices so as to incorporate a finite but discrete set of different actions specified by the seller.

A pricing model here is extended to include incentives to guarantee influence. We begin by studying the purchasing equilibria of the second stage game. By using a similar methodology described above with reference to purchasing equilibria, one can show that for any given prices and discounts there exists a PNE for the second stage game.

Theorem 4. The second stage game has at least one pure Nash equilibrium for any given vector of prices p and discounts d chosen by the seller.

In particular, if for some agent 0<α*ᵢ<1, α*ᵢ is increased to 1 while keeping the exact same value for γ*ᵢ. Therefore, by using a similar construction procedure as in theorem 1, one can obtain a PNE. In this case, a PNE is defined such that the binary purchasing decisions αᵢ are all integer. However, one can also note that there always exists an equilibrium for which the variables γᵢ are all integer as well. More precisely, if dᵢ−tᵢ>0 (remember that the prices and discounts are given), γᵢ can be increased to 1 and otherwise γᵢ=0. We therefore have the existence of a PNE with γᵢ integer as well.

One can see that a result similar to Observation 1 still holds and therefore one can characterize the equilibria (mixed and pure) as a set of constraints where the binary variables are relaxed to be continuous. In this case, one can transform subproblem (14) of agent i to a set of feasibility constraints using duality theory as follows:

$${max}_{p , d ∈ P} {\sum }_{i ∈ \vert} [ {α}_{i} ( {p}_{i} - c ) - {γ}_{i} {d}_{i} ] . \qquad ( 15 )$$

We now have two continuous dual variables yᵢ and wᵢ, together with two dual feasibility constraints for each agent i. Similar to the earlier setting, in order to restrict to the pure Nash equilibria (for the problem of optimal pricing), we impose αᵢ to be binary variables for all agents iε|. We can then formulate the optimal pricing problem faced by the seller, similar to problem Z, that maximizes the profits given in (15) with the equilibrium constraints (16)-(21), where the constraints on αᵢ are replaced by the binary versions as follows:

$$\begin{matrix}Primal feasiblity \text{:} 0 \leq {α}_{i} \leq 1 & ( 16 ) \\ 0 \leq {γ}_{i} \leq {α}_{i} & ( 17 ) \\ Dual feasiblity \text{:} {y}_{i} - {w}_{i} \geq {g}_{ii} + {\sum }_{j ∈ \vert \backslash i} {γ}_{j} {g}_{ji} - {p}_{i} & ( 18 ) \\ {w}_{i} \geq {d}_{i} - {t}_{i} & ( 19 ) \\ {y}_{i} , {w}_{i} \geq 0 & ( 20 ) \\ Strong duality \text{:} {y}_{i} = {α}_{i} ( {g}_{ii} + {\sum }_{j ∈ \vert \backslash i} {γ}_{j} {g}_{ji} - {p}_{i} ) + {γ}_{i} ( {d}_{i} - {t}_{i} ) & ( 21 )\end{matrix}$$

We denote this problem by Zi where i represents the model with incentives to guarantee influence of this present section. We impose the following assumption on the agents to address the ties in utilities.

Assumption 4. If the discount offered to agent i is such that dᵢ=tᵢ, then agent i decides to influence, i.e., γᵢ>0.

The seller can always ensure such a condition by increasing the discount by a small factor ε>0. In addition, the nature of the first stage problem guarantees this condition at optimality. One can then make the following Observation.

Observation 2. Every optimal solution of problem Zi satisfies dᵢ≦tᵢ.

Indeed, the seller can always reduce dᵢ to be equal to tᵢ while maintaining feasibility and strictly increasing the objective function. This implies that the constraint (19) is redundant in the optimal pricing problem. Consequently and by using the constraints (18)-(21), one can always assign wᵢ=0 in the pricing problem while maintaining feasibility and without altering the objective function. This observation allows us to simplify problem Zi by removing all the dual variables wᵢ ∀iε|. We next extend proposition 1 for this setting.

Proposition 2. Problem Zi admits a tight continuous relaxation. Moreover, there always exists an optimal solution to problem Zi where all the variables γ's are integer as well.

The second result in this proposition is interesting because it implies that even though the seller allows for a continuum of influence actions, the buyer would either fully influence or not influence at all. As a result, this is equivalent to the setting where the seller offers only two options: a full price pᵢ and a discounted price pᵢ−dᵢ in exchange of a specific action to influence.

Problem Zi has non-linearities of the form αᵢγⱼ, αᵢpᵢ and γᵢdᵢ. Using the discrete nature of the variables αᵢ and γᵢ from proposition 2, one can transform problem Zi to the following MIP formulation, denoted by Zi-MIP:

$$\begin{matrix}{max}_{{p , d ∈ P}_{y , z , {z}^{d} , x , α , γ}} {\sum }_{i ∈ \vert} ( {z}_{i} - {z}_{i}^{d} - c {α}_{i} ) \\ s . t . & ( Zi \text{-} MIP ) \\ \begin{matrix}{y}_{i} & = ( {α}_{i} {g}_{ii} + {\sum }_{j ∈ \vert \backslash i} {x}_{ji} {g}_{ji} - {z}_{i} ) + ( {z}_{i}^{d} - {γ}_{i} {t}_{i} ) \\ {y}_{i} & \geq {g}_{ii} + {\sum }_{j ∈ \vert \backslash i} {γ}_{j} {g}_{ji} - {p}_{i} \\ {γ}_{i} & \leq {α}_{i} \\ {y}_{i} & \geq 0\end{matrix} \} ∀ i ∈ \vert & ( 22 ) \\ \begin{matrix}{z}_{i} , {z}_{i}^{d} & \geq 0 \\ {z}_{i} & \leq {p}_{i} \\ {z}_{i} & \leq {α}_{i} {p}^{ma x} \\ {z}_{i} & \geq {p}_{i} - ( 1 - {α}_{i} ) {p}^{ma x} \\ {z}_{i}^{d} & \leq {d}_{i} \\ {z}_{i}^{d} & \leq {γ}_{i} {p}^{ma x} \\ {z}_{i}^{d} & \geq {d}_{i} - ( 1 - {γ}_{i} ) {p}^{ma x}\end{matrix} \} ∀ i ∈ \vert & ( 23 ) \\ \begin{matrix}{x}_{ji} & \geq 0 \\ {x}_{ji} & \leq {α}_{i} \\ {x}_{ji} & \leq {γ}_{j} \\ {x}_{ji } & \geq {α}_{i} + {γ}_{j} - 1\end{matrix} \} ∀ i \neq j ∈ \vert & ( 24 ) \\ {α}_{i} , {γ}_{i} ∈ \{ 0 , 1 \} ∀ i ∈ \vert & ( 25 )\end{matrix}$$

where p^{max} is the maximum price allowed. Note that we removed the dual variables wᵢ by using Observation 2. We conclude that the problem of designing prices and incentives for selling an indivisible item to agents embedded in a social network can be formulated as a MIP where one can incorporate business rules on prices and on constraints on network segmentation. However, solving a MIP may not be very scalable. For the case of discriminative prices and discounts, i.e., when P=P^{N}×P^{N}, we are able to retrieve a similar result as theorem 2. The result is summarized in the following theorem.

Theorem 5. The optimal discriminative pricing solution of the Zi-MIP problem can be obtained efficiently (polynomial in the number of agents). In particular, problem Zi-MIP with P=P^{N}×P^{N} admits a tight LP relaxation.

The main idea behind proving theorem 5 can be folded into the following two steps. First, fix the values of γᵢ, zᵢ^{d} and proceed in the same fashion as in theorem 2 to show how to construct a solution with αᵢ integer ∀iε|. Next, with the integer values of α obtained from the previous step, one can show that the objective does not change when we modify any component of γ to 0 or 1 by appropriately modifying the prices of the neighbors so that their actions do not change as in proposition 2.

In comparison to problem Z-MIP with a single price for each agent, problem Zi-MIP yields potentially lower profits for the seller. However, these profits are guaranteed whereas in the previous case, the estimated profits can be far from the actual values if people fail to influence their neighbors. The difference in profits between both settings can be viewed as the price the seller has to pay to guarantee the influence between agents in the network and can be computed efficiently by solving both settings.

It is noted that yen though our model allows a continuum of influence actions, the optimal prices can be designed in such a way that only two price options suffice. More specifically, the two options are a full price with no action required and a discounted price which requires an influence action in return.

Computational Experiments

The following description illustrates an example social network with N=10 agents.

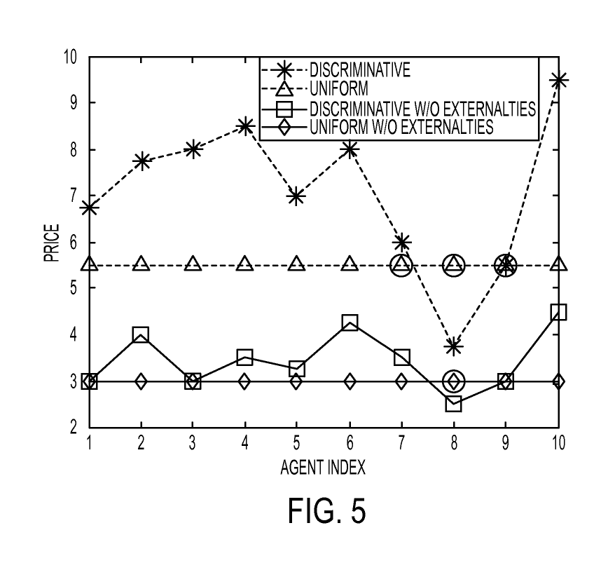

Value of incorporating network externalities: FIG. 5 shows an example plot of the optimal prices offered by the seller to the different agents under the discriminative and uniform pricing strategies with and without social interactions in one embodiment of the present disclosure. FIG. 5 illustrates the value of incorporating network externalities for the discriminative and uniform pricing strategies. The circles around the markers, whenever present, depict the fact that the agent decided not to purchase the item at the offered price (agents 7, 8 and 9 for uniform price and agent 8 for uniform without externalities). In this instance, each agent is randomly connected to three other agents with gⱼᵢ=1.25 for any connected edge, gᵢᵢ=2.5R where R is a uniform random variable in [1,2] (denoted by U[1,2]) and c=2.

We observe that by incorporating the positive externalities between the agents, the seller earns higher profits. In this particular example, the total profits are equal to 50.75 (discriminative prices) and 24.5 (uniform price) for the case with network externalities compared to 14.5 and 9 for the case without network externalities. This result is expected because every agent's willingness-to-pay increases as their neighbors positively influence them. The seller can therefore charge even higher prices and increase his profits. FIG. 5 also shows the added benefit from using a discriminative pricing strategy compared to a uniform single price. When the firm has the additional flexibility to price discriminate and offers a different price to each agent in the network, the total profits can increase significantly. In the example above, only one agent is offered a price that is lower than the optimal uniform price.

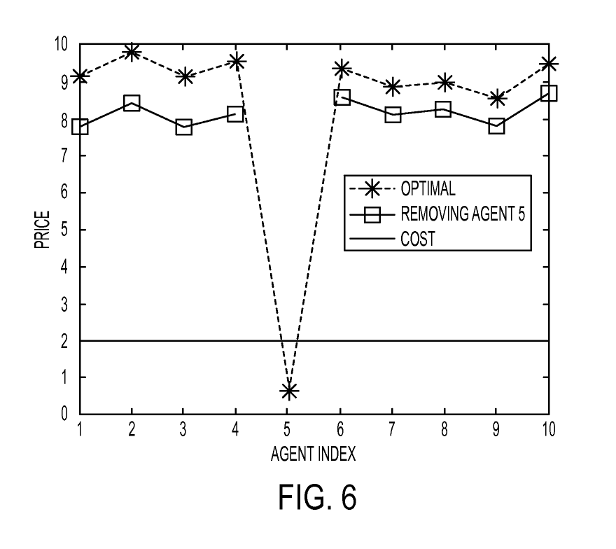

Pricing an influencer: In FIG. 6, we present an example where it is beneficial for the seller to earn negative profit (pᵢ<c) on some influential agent i in order to extract significant positive profits on his neighbors. In particular, we consider a network where agent 5 is a very influential player with g₅₅ being very low (0.075) while g₅ⱼ is sufficiently high (1.38) for the four agents that he influences. Here, gᵢⱼ=0.75 for any other connected edge, gᵢᵢ=1.5R ∀i≠5 where R=U[1,2] and c=2. FIG. 6 shows centrality effect of losing money on an influential agent.

The optimal discriminative price vector includes a price for agent 5 that happens to be lower than the cost. This illustrates the fact that agent 5 has a central and influential position in the network and therefore, the seller should strongly incentivize this player. In particular, the optimal algorithm identifies this feature and captures the fact that it is profitable to offer a very low price to this person so that he can influence other people about the product. This way, the seller loses some small amount of money on the influential agent but is able to extract higher profits on his neighbors. We now compare this to an alternate strategy where the seller decides to remove agent 5 from the network due to his low valuation. In this case, all the optimal prices are decreased and the overall profit drops from 63.52 to 55.5 units so that one can increase profits by about 14.5% by including player 5.

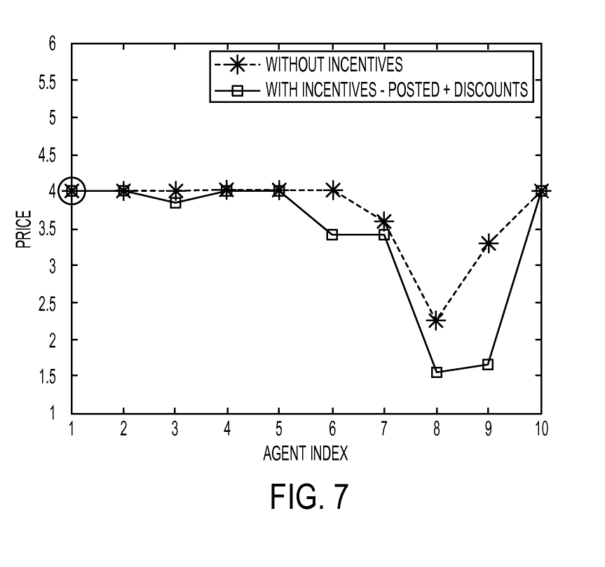

Value of incorporating incentives that guarantee influence: In FIG. 7, we compare the optimal solution for discriminative prices to the extended model introduced above where the seller offers a uniform regular price (p=4) and designs discriminative discounts in exchange of some action to influence. In this instance, every agent is randomly connected to three other agents with gⱼᵢ=0.75 for any connected edge and gᵢᵢ=1.5R where R=U[1,4.5]. We assume tᵢ=U[0,1] ∀i≠1, t₁=6.9 and c=1. FIG. 7 shows value of incorporating incentives that guarantee influence.

We observe that the total profit using the earlier model (without incentives to influence i.e., tᵢ=0) is equal to 27.15. This profit is not guaranteed because some agents may not influence their peers. In particular, in this example, suppose agents 5 and 10 who buy at full price do not influence their neighbors which includes agent 1. Agent 1 ends up not purchasing the item and consequently does not influence his neighbors either. Finally, it so happens that only agents 2, 5 and 10 buy the item yielding a profit of 9 as opposed to 27.15. Consequently, the earlier model predicts a value for the profits that is much higher than the realized one even if a few agents do not influence. On the other hand, in the model with incentives that guarantee influence (tᵢ is taken into account), the total profits are equal to 20.85 and agent 1 does not purchase the item. Observe that this is lower than 27.15 but much larger than 9. Therefore, the model with incentives provides the seller with the flexibility of using prices together with incentives that result in a higher degree of confidence on the predicted profits.

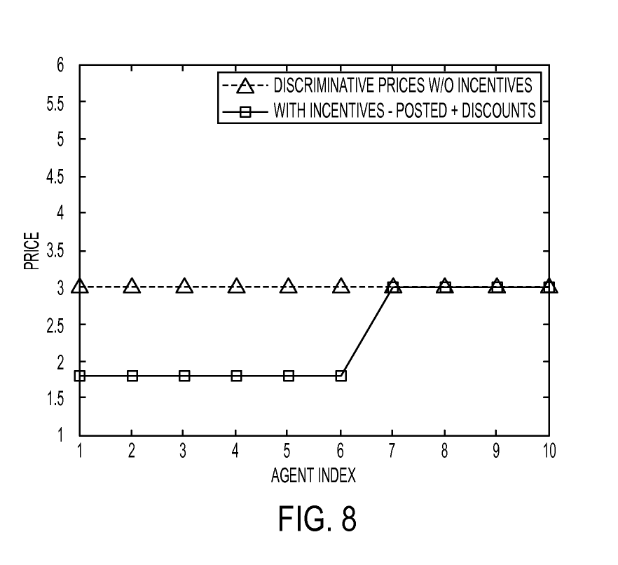

Symmetric agents with asymmetric incentives: In FIG. 8, we present a setting with symmetric agents who receive asymmetric incentives to influence their neighbors. In this instance, every agent not only has the same number of neighbors but also the same self and cross valuations. In particular, we consider a complete graph with gᵢᵢ, =1.3 and gᵢⱼ=0.3, a cost to influence tᵢ=2.2 and c=0.2. We also assume that the item has a posted price equal to 3. We compute the optimal discriminative prices which happen to be at 3 for everyone and compare them to the case where the seller designs incentives to guarantee influence by offering two prices using problem Z. Interestingly, the optimal solution for the model with incentives is not symmetric despite the fact that all the agents are homogenous. Indeed, it is sufficient for the seller to incentivize 6 out of the 10 agents in the network (no matter which group of 6). These 6 agents receive a targeted discount to influence their peers that purchase at the full posted price. FIG. 8 shows a symmetric graph with asymmetric incentives, with and without incentives.

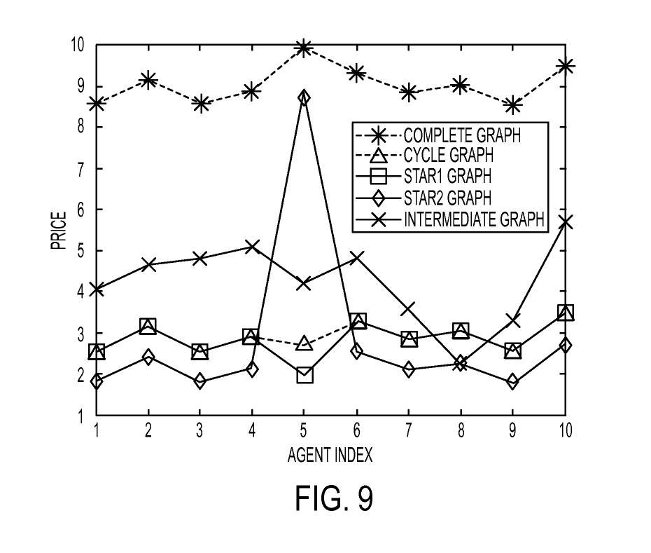

Effect of network topology on optimal prices: In FIG. 9, we consider different network topologies and compare the optimal discriminative prices as well as the corresponding profits. In all the scenarios, gᵢᵢ=1.5R where R=U[1,2], gᵢⱼ=0.75 when agent i influences agent j and 0 otherwise and c=2. For each network topology, we solve the optimal discriminative prices using the relaxation of Z-MIP. We plot the optimal price vector for the different networks in FIG. 9. We observe that in our example, all the agents always decide to purchase the item. In the complete graph, all the nodes are connected to each other and therefore the profits are the highest and equal to 70.15. In the intermediate topology where each agent has three neighbors, the total profits are equal to 22.45. The cycle graph is a network where the nodes are connected in a circular fashion, where each agent has one ingoing and one outgoing edge (influences one agent and influenced by one). In this case, the total profits are equal to 8.95. Star 1 and star 2 are star graphs with a central agent being agent 5. In star 1, agent 5 influences all the other agents and in star 2 agent 5 is influenced by all the others. In both cases, the profits are equal to 8.2. This is interesting to observe that both star networks yield the same profits as the total valuations in the system are the same. In star 1, agent 5 receives a small discount to influence so that the prices of the others are slightly higher. In star 2, the prices of all the agents but 5 are slightly lower so that the seller can charge a high price to agent 5. As we observe the prices for the different network topologies, we note that the value of the prices and the profits increase with the number of edges in the graph. Indeed, each additional edge corresponds to an agent increasing another agent's willingness-to-pay and therefore the more the graph is connected, the larger are the profits. FIG. 9 shows optimal prices for various network topologies.

The present disclosure in various embodiments presents an optimal pricing model for a profit maximizing firm that sells an indivisible item to agents embedded in a social network who interact with each other and positively influence each others' purchasing decisions. In one embodiment, we model the problem as a two stage game where the seller first offers prices and the agents collectively follow with their purchasing decisions by taking into account their neighbors influences. In one aspect, using equilibrium existential properties, duality theory and techniques from integer programming, we reformulate the two stage pricing problem as a MIP formulation with linear constraints. We view this MIP as an operational pricing tool that any firm can use by incorporating various business rules on prices and constraints on network segmentation. This formulation allows us to cast the problem into the traditional optimization framework, where one can explore and exploit various advancements in optimization techniques. For the case of discriminative and uniform pricing strategies, we present efficient methods to optimally solve the MIP that are polynomial in the number of agents using its LP relaxation.

In general, agents that buy need not necessarily influence their peers. We extend our proposed model and results to the case when the seller can design both prices and incentives to guarantee influence amongst agents. The seller can use incentives in exchange for an action such as an endorsement, a wall post or a review to guarantee influence. FIGS. 5-9 show examples of computational experiments that illustrate the benefits of incorporating network externalities, comparing the different pricing strategies and the more general model with incentives. In one aspect, it may be sometimes beneficial for the seller to earn negative profit on an influential agent in order to extract significant positive profits on others.

The optimization framework for optimal pricing of the present disclosure in one embodiment may allow one to explore decomposition techniques for other complex pricing strategies, and stochastic and robust optimization methods to handle partially observable noisy social network data.

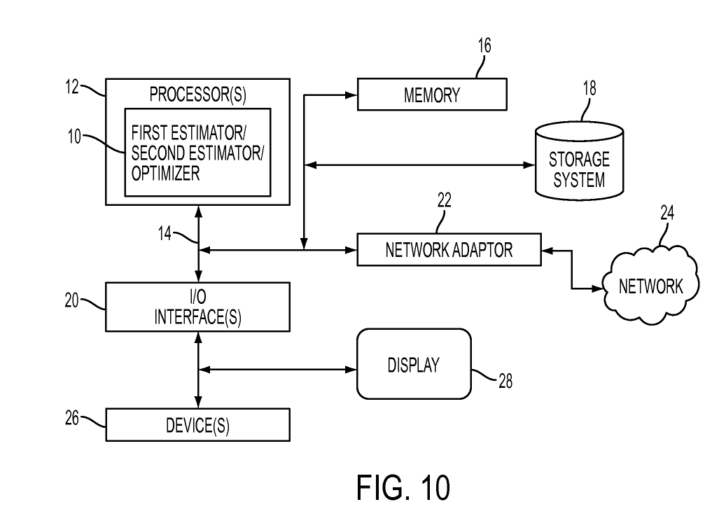

FIG. 10 illustrates a schematic of an example computer or processing system that may implement a pricing system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 10 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a pricing module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for providing a price, comprising:
a processor,
a first estimator module operable to execute on the processor and further operable to estimate a first agent's own willingness to pay for a product, for each of multiple first agents, the first estimator module further operable to estimate the first agent's influence on one or more of multiple second agents' willingness for purchasing the product, for each of the multiple first agents;
a second estimator module operable to execute on the processor and further operable to estimate an effort to influence the first agent to take an action that would influence the one or more second agents in purchasing the product, for each of the multiple first agents; and
an optimizer module operable to execute on the processor and further operable to identify simultaneously a price of the product for the first agent and an incentive for the first agent to take the action, that maximizes a profit of a seller of the product, based on at least the first agent's willingness to pay for the product, the first agent's influence, and the effort to influence the first agent.

2. The system of claim 1, further comprising a database of social media data, wherein the first agent's influence is estimated based at least on the social media data.

3. The system of claim 1, further comprising a database of historical retail data, wherein the first agent's willingness to pay for the product is estimated based at least on historical purchases of customers stored in the database of historical retail data.

4. The system of claim 3, wherein the effort to influence the first agent to take an action is estimated based at least on historical incentives provided to customers to influence stored in the database of historical retail data.

5. The system of claim 1, wherein the identifying comprises solving an optimization formulation.

6. A computer readable storage device storing a program of instructions executable by a machine to perform a method of for providing prices and incentives, comprising:
estimating a first agent's own willingness to pay for a product, for each of multiple first agents;
estimating the first agent's influence on one or more of multiple second agents' willingness for purchasing the product, for each of the multiple first agents;
estimating an effort to influence the first agent to take an action that would influence the one or more second agents in purchasing the product, for each of the multiple first agents; and
based on at least the first agent's willingness to pay for the product, the first agent's influence, and the effort to influence the first agent, identifying simultaneously a price of the product for the first agent and an incentive for the first agent to take the action, that maximizes a profit of a seller of the product.

7. The computer readable storage device of claim 6, wherein the first agent's influence is estimated based at least on social media data, the first agent's willingness to pay for a product is estimated based at least on historical purchases of customers, and the effort to influence the first agent to take an action is estimated based at least on historical incentives provided to customers to influence.

8. The computer readable storage device of claim 6, wherein the identifying comprises solving an optimization formulation, and the optimization formulation computes different prices and incentives for the multiple first agents, customized for each of the multiple first agents.
